(19) United States
(12) Patent Application Publication
(10) Pub. No.: US 2011/0188573 A1
(43) Pub. Date: Aug. 4, 2011

(54) Method and Device for Processing a Video Sequence

(75) Inventors: Guillaume Laroche, Rennes (FR); Xavier Henocq, Melesse (FR); Patrice Onno, Rennes (FR)

(73) Assignee: CANON KABUSHIKI KAISHA, Tokyo (JP)

(21) Appl. No.: 13/021,070

(22) Filed: Feb. 4, 2011

(30) Foreign Application Priority Data
Feb. 4, 2010 (FR) 1050797

(51) Int. Cl. H04N 7/34

(52) U.S. Cl. 375/240.12; 375/E07.266

(57) ABSTRACT

The invention concerns a method and a device (10, 20) for processing a video sequence (101) constituted by images composed of blocks of coefficients, and comprising the steps of:
generating (511) first and second reconstructions (402 to 413) of a (same) first image, to obtain first and second reference images (517), the second reconstruction implementing, on a coefficient of a block, a different operation to that of the first reconstruction,
predicting (505) a part (414, 415, 416) of said current image (401) on the basis of one of the reference images,
wherein the second reconstruction comprises:
the obtainment, for a block of the first image, values (Wᵢ) calculated on the basis of the block coefficients and representing spatial frequency information;
the selection of a coefficient according to these calculated values, to apply to it said different operation and obtain said second reference image.

This application claims priority from French patent application No. 10 50 797 of Feb. 4, 2010, which is incorporated herein by reference.

### FIELD OF THE INVENTION

The present invention concerns a method and device for processing, in particular for coding or decoding or more generally compressing or decompressing, a video sequence constituted by a series of digital images.

### BACKGROUND OF THE INVENTION

Video compression algorithms, such as those standardized by the standardization organizations ITU, ISO, and SMPTE, exploit the spatial and temporal redundancies of the images in order to generate bitstreams of data of smaller size than those video sequences. Such compressions make the transmission and/or the storage of the video sequences more efficient.

FIGS. 1 and 2 respectively represent the scheme for a conventional video encoder 10 and the scheme for a conventional video decoder 20 in accordance with the video compression standard H.264/MPEG-4 AVC (“Advanced Video Coding”).

The latter is the result of the collaboration between the “Video Coding Expert Group” (VCEG) of the ITU and the “Moving Picture Experts Group” (MPEG) of the ISO, in particular in the form of a publication “Advanced Video Coding for Generic Audiovisual Services” (March 2005).

FIG. 1 schematically represents a scheme for a video encoder 10 of H.264/AVC type or of one of its predecessors.

The original video sequence 101 is a succession of digital images “images i”. As is known per se, a digital image is represented by one or more matrices of which the coefficients represent pixels.

According to the H.264/AVC standard, the images are cut up into “slices”. A “slice” is a part of the image or the whole image. These slices are divided into macroblocks, generally blocks of size 16 pixels×16 pixels, and each macroblock may in turn be divided into different sizes of data blocks 102, for example 4×4, 4×8, 8×4, 8×8, 8×16, 16×8. The macroblock is the coding unit in the H.264 standard.

At the time of video compression, each block of an image in course of being processed is spatially predicted by an “Intra” predictor 103, or temporally by an “Inter” predictor 105. Each predictor is a block of pixels coming from the same image or from another image, on the basis of which a differences block (or “residue”) is deduced. The identification of the predictor block and the coding of the residue enables reduction of the quantity of information actually to be encoded.

In the “Intra” prediction module 103, the current block is predicted using an “Intra” predictor block, that is to say a block which is constructed from information already encoded from the current image.

As for the “Inter” coding, a motion estimation 104 between the current block and reference images 116 is performed in order to identify, in one of those reference images, a block of pixels to use it as a predictor of that current block. The reference images used are constituted by images of the video sequence which have already been coded then reconstructed (by decoding).

Generally, the motion estimation 104 is a “block matching algorithm” (BMA).

The predictor obtained by this algorithm is then subtracted from the current block of data to process so as to obtain a differences block (block residue). This step is called “motion compensation” 105 in the conventional compression algorithms.

These two types of coding thus provide several texture residues (difference between the current block and the predictor block) which are compared in a module 106 for selecting the best coding mode for the purposes of determining the one that optimizes a rate-distortion criterion.

If the “Intra” coding is selected, an item of information enabling the “Intra” predictor used to be described is coded (109) before being inserted into the bitstream 110.

If the module for selecting the best coding mode 106 chooses the “Inter” coding, an item of motion information is coded (109) and inserted into the bitstream 110. This item of motion information is in particular composed of a motion vector (indicating the position of the predictor block in the reference image relative to the position of the block to predict) and of an image index from among the reference images.

The residue selected by the choosing module 106 is then transformed (107) using a DCT (“Discrete Cosine Transform”), and then quantized (108). The coefficients of the quantized transformed residue are then coded using entropy or arithmetic coding (109) and then inserted into the compressed bitstream 110, for example image after image.

Below, reference will essentially be made to entropy coding. However, the person skilled in the art is capable of replacing it by arithmetic coding or any other suitable coding.

In order to calculate the “Intra” predictors or to perform the motion estimation for the “Inter” predictors, the encoder performs decoding of the blocks already encoded using a so-called “decoding” loop (111, 112, 113, 114, 115, 116) to obtain reference images. This decoding loop enables the blocks and the images to be reconstructed on the basis of the quantized transformed residues.

It ensures that the coder and the decoder use the same reference images.

Thus, the quantized transformed residue is dequantized (111) by application of a quantization operation that is inverse to that provided at step 108, then reconstructed (112) by application of the transform that is inverse to that of step 107.

If the residue comes from “Intra” coding 103, the “Intra” predictor used is added to that residue (113) to retrieve a reconstructed block corresponding to the original block modified by the losses resulting from the quantization operation.

If, on the other hand, the residue comes from “Inter” coding 105, the block pointed to by the current motion vector (this block belonging to the reference image 116 referred to by the current image index) is added to that decoded residue (114). The original block is thus obtained modified by the losses resulting from the quantization operations.

In order to attenuate, within the same image, the block effects created by a strong quantization of the residues obtained, the encoder integrates a “deblocking” filter 115, the object of which is to eliminate those block effects, in particular the artificial high frequencies introduced at the boundaries between blocks. The deblocking filter 115 enables the boundaries between the blocks to be smoothed in order to visually attenuate those high frequencies created by the coding. As such a filter is known from the art, it will not be described in more detail here.

The filter 115 is thus applied to an image when all the blocks of pixels of that image have been decoded.

The filtered images, also termed reconstructed images, are then stored as reference images 116 to enable the later “Inter” predictions taking place on compression of the following images of the current video sequence.

For the following part of the explanations, “conventional” will be used to refer to the information resulting from that decoding loop implemented in the state of the art, that is to say in particular by inversing the quantization and the transform with conventional parameters. Henceforth reference will be made to “conventional reconstructed image”.

In the context of the H.264 standard, it is possible to use several reference images 116 for the motion compensation and estimation of the current image, with a maximum of 32 reference images.

In other words, the motion estimation is carried out over N images. Thus, the best “Inter” predictor of the current block, for the motion compensation, is selected in one of the multiple reference images. Consequently, two neighboring blocks may have two predictor blocks which come from two separate reference images. This is in particular the reason why, in the compressed bitstream, with regard to each block of the coded image (in fact the corresponding residue), the index of the reference image used for the predictor block is indicated (in addition to the motion vector).

FIG. 3 illustrates this motion compensation using a plurality of reference images. In this Figure, the image 301 represents the current image in course of coding corresponding to the image i of the video sequence.

The images 302 to 307 correspond to the images i-1 to i-n which were previously encoded then decoded (that is to say reconstructed) from the compressed video sequence 110.

In the illustrated example, three reference images 302, 303 and 304 are used in the Inter prediction of blocks of the image 301. To make the graphical representation legible, only a few blocks of the current image 301 have been represented, and no Intra prediction has been illustrated here.

In particular, for the block 308, an Inter predictor 311 belonging to the reference image 303 is selected. The blocks 309 and 310 are respectively predicted by the block 312 of the reference image 302 and the block 313 of the reference image 304. For each of these blocks, a motion vector (314, 315, 316) is coded and transmitted with the reference image index (314, 315, 316).

The use of multiple reference images_the recommendation of the aforementioned VCEG group may however be noted recommending to limit the number of reference images to four_is both an error resilience tool and a tool for improving the compression efficiency.

This is because, with a suitable selection of the reference images for each of the blocks of a current image, it is possible to limit the effect of the loss of a reference image or of a part of a reference image.

In the same way, if the selection of the best reference image is estimated block by block with a minimum rate-distortion criterion, this use of several reference images makes it possible to obtain significant savings relative to the use of a single reference image.

However, to obtain these improvements, it is necessary to perform a motion estimation for each of the reference images, which increases the calculating complexity for a video coder.

Furthermore, the set of reference images needs to be kept in memory, increasing the memory space required in the encoder.

Thus, the complexity of calculation and of memory, required for the use of several reference images according to the H.264 standard, may prove to be incompatible with certain video equipment or applications of which the capacities for calculation and for memory are limited. This is the case, for example, for mobile telephones, stills cameras or digital video cameras.

FIG. 2 represents an overall scheme for a video decoder 20 of H.264/AVC type. The decoder 20 receives a bitstream 201 as input corresponding to a video sequence 110 compressed by an encoder of H.264/AVC type, such as that of FIG. 1.

During the decoding process, the bitstream 201 is first of all decoded entropically (202), which enables each coded residue to be processed.

The residue of the current block is dequantized (203) using the inverse quantization to that provided at 108, then reconstructed (204) using the inverse transform to that provided at 107.

The decoding of the data of the video sequence is then carried out image by image, and within an image, block by block.

The “Inter” or “Intra” coding mode of the current block is extracted from the bitstream 201 and decoded entropically.

If the coding of the current block is of “Intra” type, the index of the predictor block is extracted from the bitstream and decoded entropically. The Intra predictor block associated with that index is calculated using the data already decoded of the current image.

The residue associated with the current block is retrieved from the bitstream 201 then decoded entropically. Lastly, the retrieved Intra predictor block is added to the residue thus quantized and reconstructed in the inverse Intra prediction module (205) to obtain the decoded block.

If the coding mode of the current block indicates that this block is of “Inter” type, then the motion information, and possibly the identifier of the reference image used, are extracted from the bitstream 201 and decoded (202).

This motion information is used in the inverse motion compensation module 206 to determine the “Inter” predictor block contained in the reference images 208 of the decoder 20. In similar manner to the encoder, these reference images 208 are composed of images preceding the image in course of decoding and which are reconstructed on the basis of the bitstream (thus previously decoded).

The residue associated with the current block is, here too, retrieved from the bitstream 201 and then decoded entropically. The determined Inter predictor block is then added to the residue thus dequantized and reconstructed, in the inverse motion compensation module 206 to obtain the decoded block.

At the end of the decoding of all the blocks of the current image, the same deblocking filter 207 as that (115) provided at the encoder is used to eliminate the block effects so as to obtain the reference images 208.

The images thus decoded constitute the video signal 209 output from the decoder, which may then be displayed and exploited.

These decoding operations are similar to the decoding loop of the coder. In this report, the illustration of FIG. 3 also applies to the decoding.

In a way that mirrors the coding, the decoder in accordance with the H.264 standard requires the use of several reference images.

### SUMMARY OF THE INVENTION

In this context, the inventors have provided a method of processing a video sequence constituted by a series of digital images comprising a current image to process, said images being composed of data blocks each formed from a set of coefficients each taking a value. The method comprises the steps of:
generating at least first and second reconstructions, which are different from each other, of at least a first image of the sequence (i.e. a same first image), so as to obtain at least first and second reference images, the second reconstruction (of this same first image) implementing, on at least one coefficient of a block, a different operation to that implemented at the first reconstruction (of this same first image) on the same block coefficient;
predicting at least a part of said current image on the basis of at least one of said reference images.

By way of example, the different operations may concern a different inverse quantization or different inverse transformation.

This approach makes it possible in particular to predict a part of the current image from the first reference image corresponding to a first image of the sequence, and to predict another part of the current image from at least one second reference image corresponding to the same first image of the sequence.

Thus, the reference images result from several different reconstructions of one or more images of the video sequence, generally from among those which were encoded/decoded before the current image to process (in this connection see FIG. 4).

Just as for the H.264 standard, this enables the use of a high number of reference images, with however better versions of the reference images than those conventionally used. A better compression thus results thereby than by using a single reference image per image already coded.

Furthermore, this approach contributes to reducing the memory space necessary for the storage of the same number of reference images at the encoder or decoder. This is because, a single reference image (generally the one reconstructed in accordance with the techniques known from the state of the art) may be stored and, by producing, on the fly, the other reference images corresponding to the same image of the video sequence (the second reconstructions), several reference images are obtained for a minimum occupied memory space.

Moreover, it has been possible to observe that, for numerous sequences, the use, according to the invention, of reference images reconstructed from the same image proves to be more efficient than the use of the “conventional” multiple reference images as in H.264, which are encoded/decoded images taken at different temporal offsets relative to the image to process in the video sequence. This results in a reduction in the entropy of the “Inter” texture residues and/or in the quality of the “Inter” predictor blocks.

As is known per se, the blocks composing an image comprise a plurality of coefficients each having a value. The manner in which the coefficients are scanned within the blocks, for example a according to zig-zag scan, defines a coefficient number for each block coefficient. For the following part of the description, “block coefficient”, “coefficient index” and “coefficient number” will be used in the same way to indicate the position of a coefficient within a block according to the scan adopted. Moreover, “coefficient value” will be used to indicate the value taken by a given coefficient in a block.

The present invention concerns producing multiple reconstructions of the same image which provide, at lower cost, better versions of reference images for the later predictions.

To that end, the invention concerns in particular the processing method introduced above, wherein the second reconstruction of the first image comprises the steps consisting of:
obtaining, for at least one block of the first image, values calculated on the basis of the block coefficients and representing spatial frequency information;
selecting at least one block coefficient according to said calculated values, and applying said different operation to it so as to obtain said second reference image.

Thus a (spatial)-frequency analysis is conducted to determine one or more significant coefficients in a block or more generally in the image, on the basis of which another reconstruction is carried out.

As a matter of fact, the frequency analysis makes it possible, at lower cost, to identify the changing parts of the image (edges, horizontal change, etc.). The invention thus enables reconstructions to be generated taking into account those changes, which on average improves the later predictions.

Furthermore, this localized prediction of the coefficients to modify (at the time of the different operation) may be carried out in similar manner at the coder and at the decoder. Consequently, in this case, the invention makes it possible to dispense with the transmission of information relative to those coefficients to modify, within the coded stream. This results in a lower coding cost for the same video sequence.

In an embodiment, the second reconstruction of the first image further comprises a step of determining a subset of block coefficients, according to said calculated values;

and selecting at least one block coefficient is carried out on said subset.

The invention thus makes it possible to reduce the complexity of the selecting operation by restricting the number of coefficients on which selection calculations are carried out.

According to a feature of the invention, determining said subset comprises calculating, for each block coefficient and on the basis of said calculated values, at least a second value representing the relative importance of the block coefficients compared with each other within said first image, and determining coefficients to constitute said subset by comparison of the second values with a threshold value. The coefficients are important if their values (for example the sum of the coefficients with the same number for all the blocks of the image, or the value of the coefficient in a given block) are significant relative to the others.

This provision ensures that the constructed subset contains coefficients whose values are very significant. Thus, the other reconstructions implementing modified reconstructions for one of these coefficients are certainly reference images that are sufficiently distinct from the conventional reference image to improve the effectiveness of the predictions.

Moreover, the user may adjust the complexity of the calculations by modifying the threshold value and thus indirectly modifying the size of said subset.

In an embodiment of the invention, the method comprises a plurality of different reconstructions of the first image, and the second reconstruction of the first image further comprises the step of deleting, from said subset, a coefficient on which said different operation has already been applied for a predefined number of reconstructions of the first image. In other words, always modifying the same coefficient at the time of “other” reconstructions is avoided. A more disparate set of reference images is thus obtained for a more efficient compression.

In another embodiment, given a selected coefficient, the second reconstruction comprises applying the different operation to said selected coefficient for each block of the first image to reconstruct. This provision, designated “global approach” hereinafter, provides lower complexity since the same modification is applied to all the blocks of the image to reconstruct.

As a variant or in combination, at the second reconstruction, the steps to obtain said calculated values and to select at least one coefficient are carried out repetitively for several blocks of the first image, so as to obtain a particular coefficient for each of those several blocks, and, in a said block, an operation is applied to said particular coefficient which operation is different to that implemented at the first reconstruction on the same block coefficient. In other words, this provision, designated “local approach” hereinafter, provides for analyzing each block individually and for performing a reconstruction operation specific to each block. This results in an improvement of the coding efficiency since the coding of each block may be optimized.

In particular, at the second reconstruction, a said different operation is applied to at least one said first coefficient for each block of the first image to reconstruct and a said different operation is applied, for each block of the first image, to a particular selected coefficient of said block, and,

selecting said particular coefficient before applying said different operation is carried out from a set of block coefficients excluding said at least one first coefficient. This first coefficient may of course be selected as mentioned previously for the “global approach”.

Here, global approach and local approach are combined, avoiding, for a particular block, performing modifications to a coefficient already modified globally. The spread of the modifications to the different block coefficients is thus promoted in order to obtain more disparate reference images.

In one embodiment, the calculated values representing spatial frequency information are obtained by transforming the first reference image resulting from the first reconstruction. In this configuration, an analysis is carried out in particular on the basis of a reference image already generated, in particular the “conventional” reference image. As the decoder may have available this reference image already created via the bitstream, that same decoder may be capable of performing the same selecting process and thus be capable of obtaining the second reconstruction itself, while transmitting a minimum of information into the bitstream (in particular transmitting calculated values may be avoided). The compression of the sequence is thus improved.

As a variant, the calculated values are obtained by transformation of said first image, that is to say the original image independently of any reconstruction. In this case, there is generally a need to send the selected coefficients to the decoder in the bitstream, since that same decoder does not know that first image.

As a further variant, the first reconstruction comprises an inverse quantization of the coefficient values coming from a quantized version of said first image, and said calculated values, for the second reconstruction, are calculated on the basis of the dequantized coefficient values obtained at the inverse quantization of the first reconstruction. In this case and in particular when the first reconstruction is the “conventional” reconstruction, the coefficients transformed at that “conventional” reconstruction are retrieved. In this configuration, processing operations of no use, in particular a transform operation of no use, are avoided.

As a further variant, said calculated values are calculated for each block coefficient and represent a gradient in the neighborhood of the block coefficient. The approach by analysis of the gradients also enables an efficient selection of the coefficients to modify to obtain disparate reference images and improve the compression of the video sequence.

In an embodiment, the operation that is different from the second reconstruction implements an inverse quantization using, for said at least one selected block coefficient, a different quantization offset to that used for the same coefficient at the first reconstruction. The quantization offset is also named reconstruction offset.

This provision makes it possible to have reference images that are adapted to the lossy video compression algorithms including quantization mechanisms. Furthermore, the use of the quantization offsets makes it possible to control the quantization ranges and provide, without technical complexity, predictors of better quality for some blocks.

In an embodiment, for the set of the blocks composing a first given image, there is uniquely associated with a block coefficient a parameter defining said different operation to apply, for each block, to the block coefficient if it is selected,

and the method comprises a step of coding the current image into a coded stream and a step of inserting, into the coded stream, said parameters for the set of the blocks of a current image in the form of a unique list organized in a predetermined order.

Here, the same parameter (for example a quantization offset) is uniquely associated with a block coefficient number for the set of blocks of the current image. There is thus a limited number of parameters to transmit. In this configuration, the invention transmits these parameters in a single transmission for the whole of the current image, without transmitting them block by block. Better compression of the video sequence is thus obtained since these parameters are not unnecessarily repeated in the coded stream

The invention also relates to a device, for example a coder or decoder, for processing a video sequence constituted by a series of digital images comprising a current image to process, said images being composed of data blocks each formed from a set of coefficients each taking a value. The device comprises in particular:
a generating means adapted for generating at least first and second reconstructions, which are different from each other, of at least a first image of the sequence, so as to obtain at least first and second reference images, the second reconstruction implementing, on at least one coefficient of a block, a different operation to that implemented at the first reconstruction on the same block coefficient;
a predicting means adapted for predicting at least a part of said current image on the basis of at least one of said reference images;

and wherein the generating means for generating the second reconstruction comprises:
a means for obtaining, for at least one block of the first image, values calculated on the basis of the block coefficients and representing spatial frequency information;
a means for selecting at least one block coefficient according to said calculated values, and applying said different operation to it so as to obtain said second reference image.

The processing device has similar advantages to those of the processing method set out above, in particular of enabling the reduced use of memory resources, of performing calculations of reduced complexity or improving the Inter predictors used at the motion compensation.

Optionally, the device may comprise means relating to the features of the method set out above.

The invention also concerns an information storage means, possibly totally or partially removable, that is readable by a computer system, comprising instructions for a computer program adapted to implement the processing method in accordance with the invention when that program is loaded and executed by the computer system.

The invention also concerns a computer program readable by a microprocessor, comprising portions of software code adapted to implement the processing method in accordance with the invention, when it is loaded and executed by the microprocessor.

The information storage means and computer program have features and advantages that are analogous to the methods they implement.

### BRIEF DESCRIPTION OF THE DRAWINGS

Still other particularities and advantages of the invention will appear in the following description, illustrated by the accompanying drawings, in which:

FIG. 1 shows the general scheme of a video encoder of the state of the art.

FIG. 2 shows the general scheme of a video decoder of the state of the art.

FIG. 3 illustrates the principle of the motion compensation of a video coder according to the state of the art;

FIG. 4 illustrates the principle of the motion compensation of a coder including, as reference images, multiple reconstructions of at least one same image;

FIG. 5 represents the general scheme of a video encoder according to a first embodiment of the invention;

FIG. 6 represents the general scheme of a video decoder according to the first embodiment of the invention;

FIG. 7 represents the general scheme of a video encoder according to a second embodiment of the invention;

FIG. 8 represents the general scheme of a video decoder according to the second embodiment of the invention;

FIG. 9 shows a particular hardware configuration of a device adapted for an implementation of the method or methods according to the invention;

FIG. 10 illustrates particularities of a coder according to the invention for the implementation of a first algorithm for selecting “local” coefficients to modify for a “second” reconstruction, for example of the coder of FIG. 7;

FIG. 11 illustrates particularities of a decoder according to the invention for the implementation of the first algorithm, for example of the decoder of FIG. 7;

FIG. 12 illustrates particularities of a coder according to the invention for the implementation of a second algorithm for selecting “local” coefficients to modify for a “second” reconstruction, for example of the coder of FIG. 8; and

FIG. 13 illustrates particularities of a coder according to the invention for the implementation of a third algorithm for selecting “local” coefficients to modify for a “second” reconstruction, for example of the coder of FIG. 7.

### DETAILED DESCRIPTION OF PREFERRED EMBODIMENTS

According to the invention, the method of processing a video sequence of images comprises generating two or more different reconstructions of at least one same image that precedes the image to process (to code or decode) in the video sequence, so as to obtain at least two reference images for the motion compensation.

The processing operations on the video sequence may be of a different nature, including in particular video compression algorithms. In particular, the video sequence may be subjected to coding for the purpose of transmission or storage.

For the following part of the description, consideration will more particularly be given to processing of motion compensation type applied to an image of the sequence, in the context of video compression. However, the invention could be applied to other processing operations, for example to motion estimation on sequence analysis.

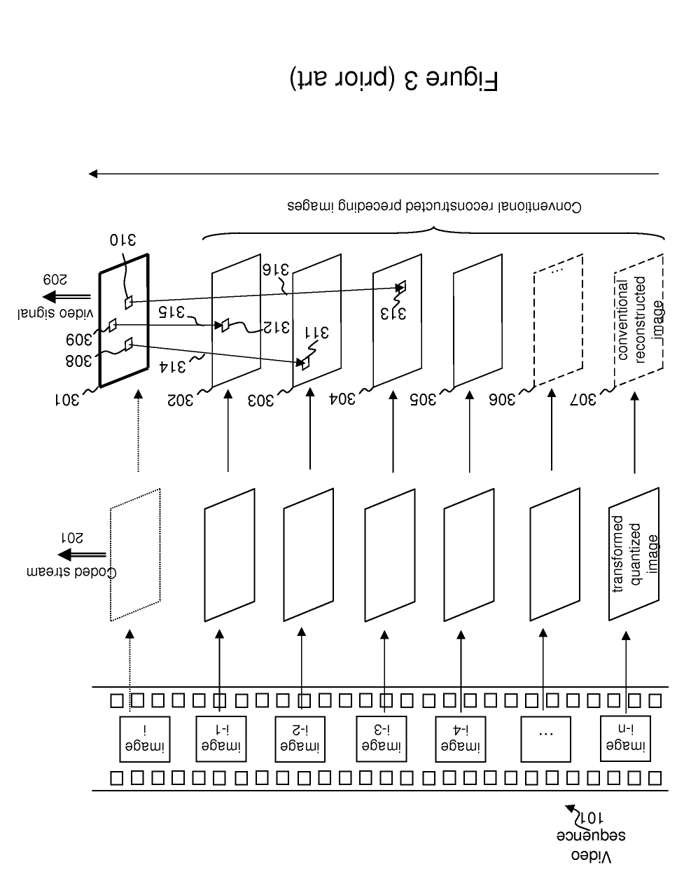

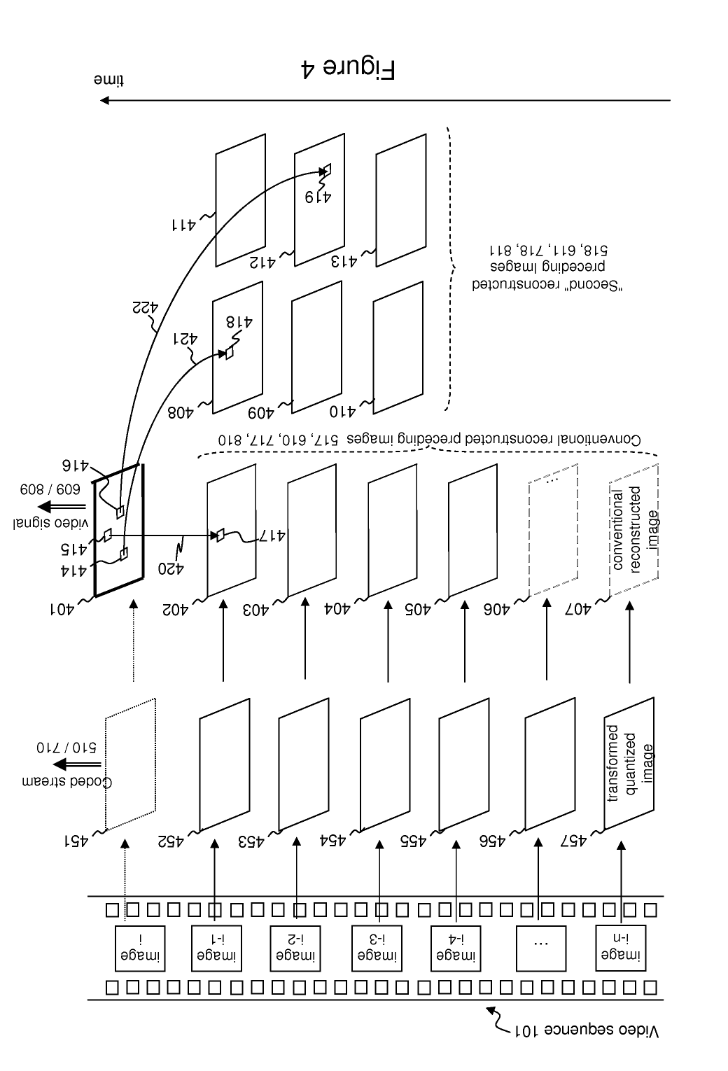

FIG. 4 illustrates a motion compensation implementing the invention, in a similar representation to that of FIG. 3.

The “conventional” reference images 402 to 405, that is to say obtained using the techniques of the prior art, and the new reference images 408 to 413 generated by the present invention are represented on an axis perpendicular to that of time (defining the video sequence 101) in order to show which images generated by the invention correspond to the same conventional reference image.

More particularly, the conventional reference images 402 to 405 are images of the video sequence which were previously encoded then decoded by the decoding loop: these images thus correspond to the video signal 209 of the decoder.

The images 408 and 411 result from other instances of decoding the image 452, also termed “second” reconstructions of the image 452. The “second” instances of decoding or reconstructions signify instances of decoding/reconstructions with different parameters to those used for the conventional decoding/reconstruction (in a standard coding format for example) provided to generate the decoded video signal 209.

As seen subsequently, these different parameters may comprise a DCT block coefficient and a quantization offset θᵢ applied at the time of reconstruction.

Similarly, the images 409 and 412 are instances of second decoding of the image 403. Lastly, the images 410 and 413 are instances of second decoding of the image 404.

According to the invention as illustrated in this example, the current image blocks (i, 401) which must be processed (compressed) may each be predicted by a block of the previously decoded images 402 to 407 or by a block from a “second” reconstruction 408 to 413 of one of those images 452 to 454.

In this Figure, the block 414 of the current image 401 has, as Inter predictor block, the block 418 in the reference image 408 which is a “second” reconstruction of the image 452. The block 415 of the current image 401 has, as predictor block, the block 417 in the conventional reference image 402. Lastly, the block 416 has as predictor the block 419 in the reference image 413 which is a “second” reconstruction of the image 453.

In general terms, the “second” reconstructions 408 to 413 of a conventional reference image or of several conventional reference images 402 to 407 may be added to the list of the reference images 116, 208, or even replace one or more of those conventional reference images.

It will be noted that, generally, it is more efficient to replace the conventional reference images by “second” reconstructions, and to keep a limited number of new reference images (reconstructed multiples), rather than always to add these new images to the list. More particularly, a high number of reference images in the list increases the rate necessary for the coding of an index of those reference images (to indicate to the decoder which to use).

Similarly, it has been possible to observe that the use of multiple “second” reconstructions of the first reference image (that which is the closest temporally to the current image to process, generally the image preceding it) is more efficient than the use of multiple reconstructions of a temporally more remote reference image.

In order to identify the reference images used during the encoding, the encoder transmits, in addition to the count number and reference number of the reference images, a first indicator or flag to indicate whether the reference image associated with the reference number is a conventional reconstruction or a “second” reconstruction. If the reference image arises from a “second” reconstruction according to the invention, the parameters relative to that second reconstruction (“coefficient number”, “reconstruction offset value”, and indicator relative to the global or local approach use, etc. as described below) are transmitted to the decoder, for each of the reference images used.

In a variant of this signaling, the coder transmits the count number of reference images to the decoder, then it indicates the reference number of the first reference image followed by the count number of reconstructions of that image. By considering that the first reconstruction is always a conventional reconstruction, the “coefficient number” and “reconstruction offset value” parameters, etc., are transmitted solely for the other reconstructions. If the count number of reference images has not been reached, the encoder thus registers the reference number of another reference image followed by the number of reconstructions used for that image.

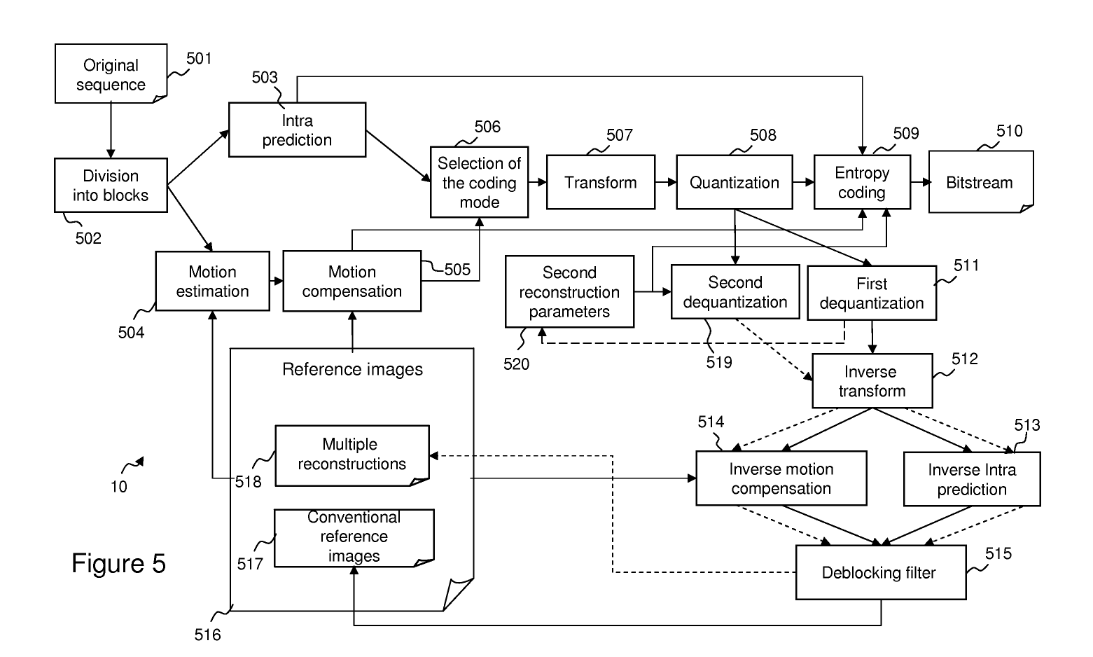

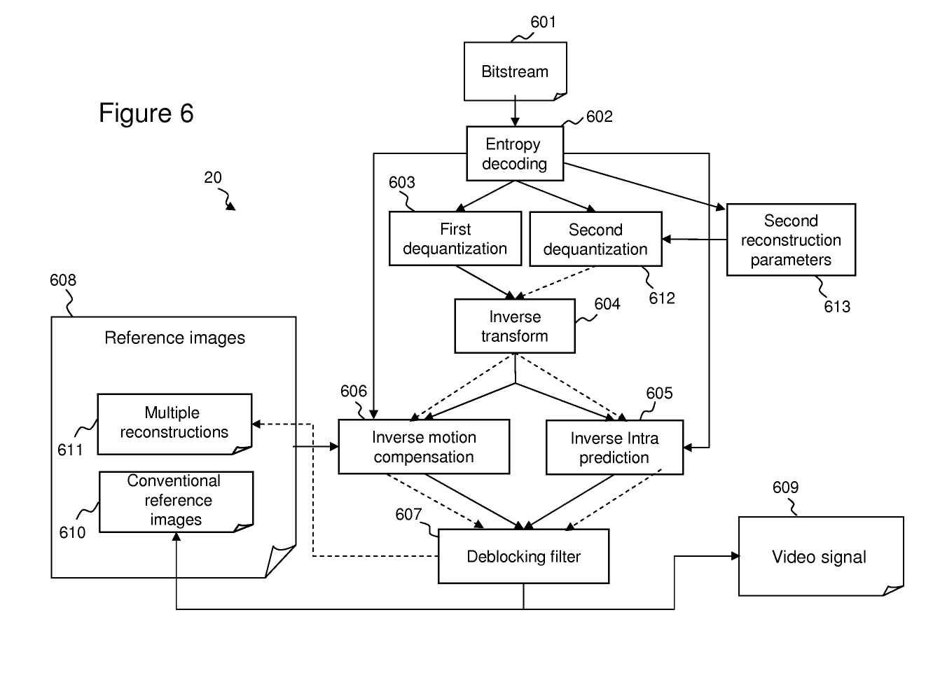

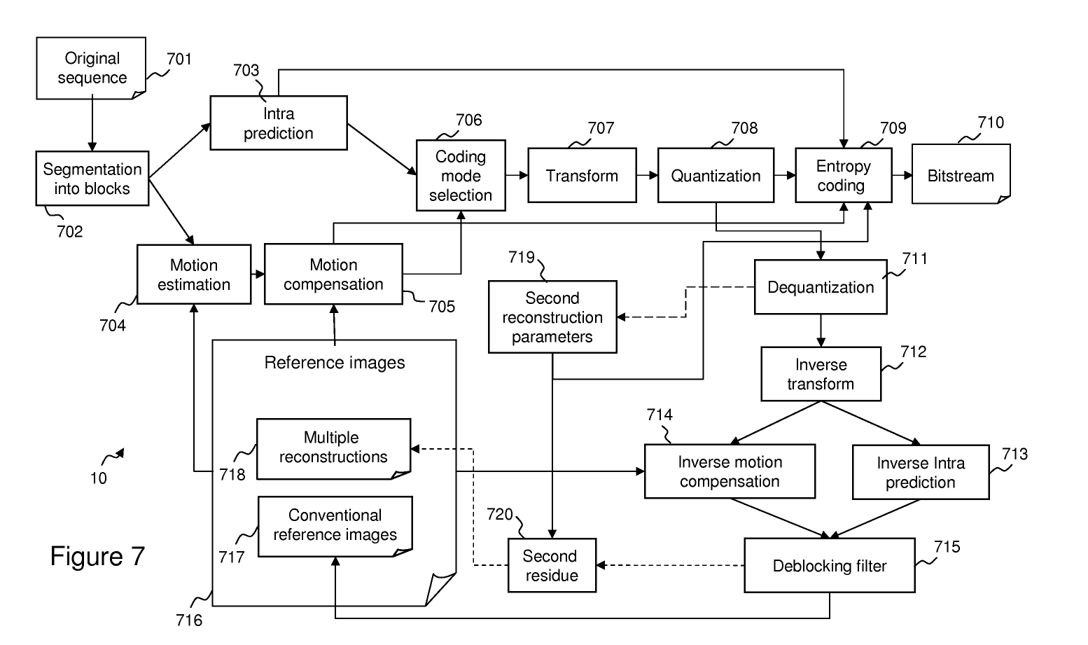

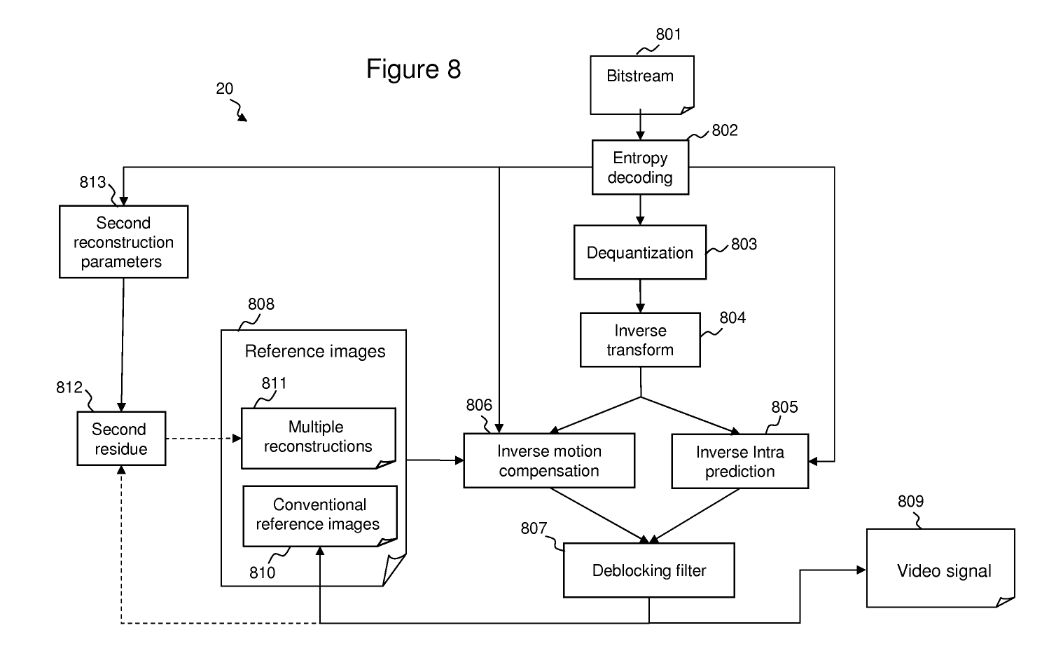

With reference to FIGS. 5 to 8, a description will now be given of two main embodiments of the invention to generate multiple reconstructions of a conventional reference image, both at the time of the encoding of a video sequence, and at the time of the decoding of an encoded sequence. The second embodiment (FIGS. 7 and 8) employs approximations of the first embodiment (FIGS. 5 and 6) in order to give lower complexity while maintaining similar performance in terms of rate-distortion of the encoded/decoded video sequence.

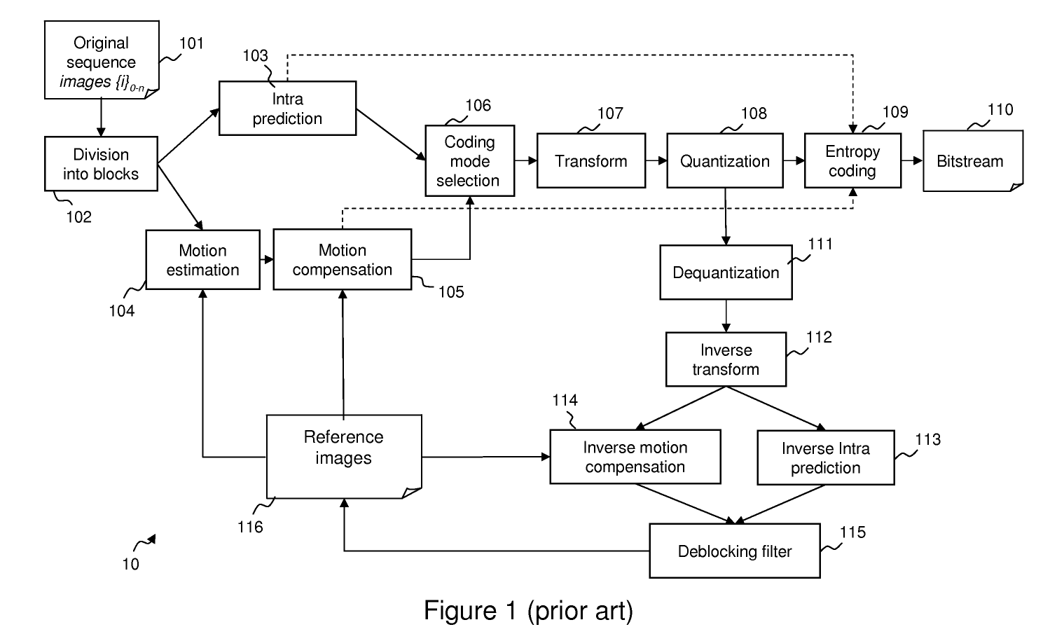

With reference to FIG. 5, a video encoder 10 according to the first embodiment of the invention comprises modules 501 to 515 for processing a video sequence with decoding loop, similar to the modules 101 to 115 of FIG. 1.

In particular, according to the H.264 standard, the quantization module 108/508 performs a quantization of the residue obtained after transformation 107/507, for example of DCT type, on the residue of the current block of pixels. The quantization is applied to each of the N coefficient values of that residual block (as many coefficients as there are in the initial block of pixels). The calculation of a matrix of DCT coefficients and the scan path of the coefficients within the matrix of DCT coefficients are concepts widely known to the person skilled in the art and will not be detailed further here. Such a scan path through the matrix of DCT coefficients makes it possible to obtain an order of the coefficients in the block, and therefore an index number for each of them.

Thus, if the value of the i^{th} coefficient of the residue of the current block is called Wᵢ (with i from O to M−1 for a block containing M coefficients), the quantized coefficient value Zᵢ is obtained by the following formula:

$${Z}_{i} = int ( \frac{\vert {W}_{i} \vert + {f}_{i}}{{q}_{i}} ) \cdot sgn ( {W}_{i} )$$

where qᵢ is the quantizer associated to the i^{th} coefficient whose value depends both on a quantization step size denoted QP and the position (that is to say the number or index) of the coefficient value Wᵢ in the transformed block.

To be precise, the quantizer qᵢ comes from a matrix referred to as a quantization matrix of which each element (the values qᵢ) is predetermined. The elements are generally set so as to quantize the high frequencies more strongly.

Furthermore, the function int(x) supplies the integer part of the value x and the function sgn(x) gives the sign of the value x

Lastly, fᵢ is the quantization offset which enables the quantization interval to be centered. If this offset is fixed, it is general equal to qᵢ/2.

On finishing this step, the quantized residual blocks are obtained for each image, ready to be coded to generate the bitstream 510. In FIG. 4, these images bear the references 451 to 457.

The inverse quantization (or dequantization) process, represented by the module 111/511 in the decoding loop of the encoder 10, provides for the dequantized value Wᵢ′ of the i^{th} coefficient to be obtained by the following formula:

Wᵢ′=(qᵢ·|Zᵢ|−θᵢ)·sgn(Zᵢ).

In this formula, Zᵢ is the quantized value of the i^{th} coefficient, calculated with the above quantization equation. θᵢ is the reconstruction offset that makes it possible to center the reconstruction interval. By nature, θᵢ must belong to the interval [−|fᵢ|;|fᵢ|]. To be precise, there is a value of θᵢ belonging to this interval such that Wᵢ′=Wᵢ. This offset is generally equal to zero.

It should be noted that this formula is also applied by the decoder 20, at the dequantization 203 (603 as described below with reference to FIG. 6).

Still with reference to FIG. 5, box 516 contains the reference images in the same way as box 116 of FIG. 1, that is to say that the images contained in this module are used for the motion estimation 504, the motion compensation 505 on coding a block of pixels of the video sequence, and the inverse motion compensation 514 in the decoding loop for generating the reference images.

To illustrate the present invention, the reference images 517 referred to as “conventional” have been shown schematically, within box 516, separately from the reference images 518 obtained by “second” decoding/reconstruction according to the invention.

In this first embodiment of the invention, the “second” reconstructions of an image are constructed within the decoding loop, as represented by the modules 519 and 520, allowing at least one “second” decoding by dequantization (519) using “second” reconstruction parameters (520).

Thus, for each of the blocks of the current image, two dequantization processes (inverse quantization) 511 and 519 are used: the conventional inverse quantization 511 for generating a first reconstruction and the different inverse quantization 519 for generating a “second” reconstruction of the block (and thus of the current image).

It should be noted that, in order to obtain multiple “second” reconstructions of the current reference image, a larger number of modules 519 and 520 may be provided in the encoder 10, each generating a different reconstruction with different parameters as explained below In particular, all the multiple reconstructions can be executed in parallel with the conventional reconstruction by the module 511.

Information on the number of multiple reconstructions and the associated parameters are inserted in the coded stream 510 for the purpose of informing the decoder 20 of the values to use.

The module 519 receives the parameters of a second reconstruction 520 different from the conventional reconstruction. The operation of this module 520 will be described below. The parameters received are for example a coefficient number i of the transformed residue which will be reconstructed differently and the corresponding reconstruction offset θᵢ, as described elsewhere The number of a coefficient is typically its number in a convention order such as a zig-zag scan.

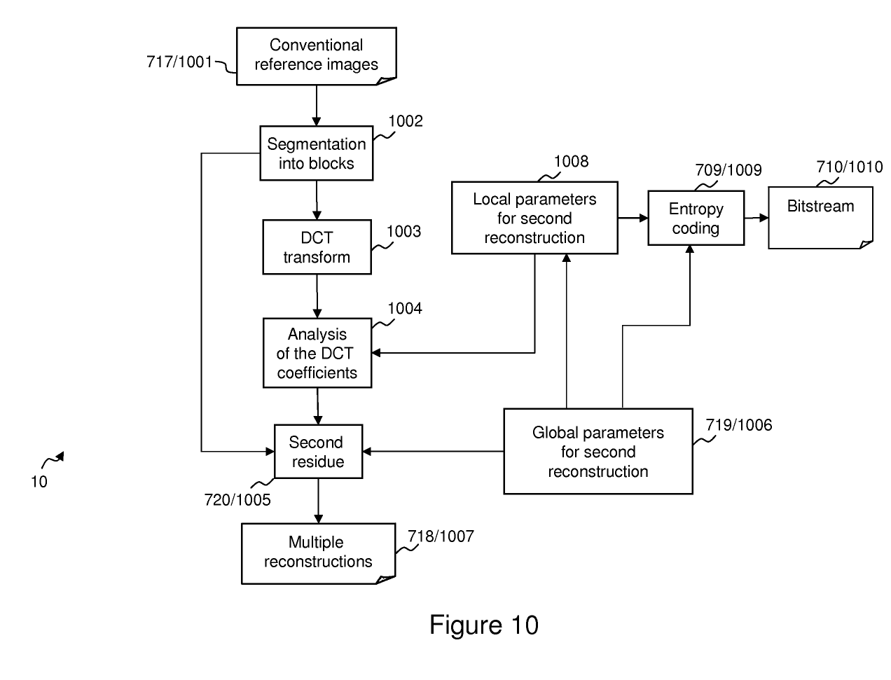

These parameters may in particular be determined in advance and be the same for the entire reconstruction (that is to say for all the blocks of pixels) of the corresponding reference image. In this case, these parameters are transmitted only once to the decoder for the image. However, as described below with reference to FIGS. 10 to 13, it is possible to have parameters which vary from one block to another and to transmits those parameters (coefficient number and offset θᵢ) block by block. Still other mechanisms will be referred to below.

These two parameters generated by the module 520 are entropically encoded at module 509 then inserted into the binary stream (510)

In module 519, the inverse quantization for calculating Wᵢ′ is applied for the coefficient i and the reconstruction offset θᵢ that are defined in the parameters 520. In an embodiment, for the other coefficients of the block, the inverse quantization is applied with the conventional reconstruction offset (used in module 511). Thus, in this example, the “second” reconstructions may differ from the conventional reconstruction by the use of a single pair (coefficient, offset).

In particular, if the encoder uses several types of transform or several transform sizes, a coefficient number and a reconstruction offset are transmitted to the decoder for each type or each size of transform.

As will be seen below, it is however possible to apply several reconstruction offsets θᵢ to several coefficients within the same block.

At the end of the second inverse quantization 519, the same processing operations as those applied to the “conventional” signal are performed. In detail, an inverse transformation 512 is applied to that new residue (which has thus been transformed 507, quantized 508, then dequantized 519). Next, depending on the coding of the current block (Intra or Inter), an inverse motion compensation 514 or an inverse Intra prediction 513 is performed.

Lastly, when all the blocks (414, 415, 416) of the current image have been decoded, this new reconstruction of the current image is filtered by the deblocking filter 515 before being inserted among the multiple “second” reconstructions 518.

Thus, in parallel, there are obtained the image decoded via the module 511 constituting the conventional reference image, and one or more “second” reconstructions of the image (via the module 519 and other similar modules the case arising) constituting other reference images corresponding to the same image of the video sequence.

In FIG. 5, the processing according to the invention of the residues transformed, quantized and dequantized by the second inverse quantization 519 is represented by the arrows in dashed lines between the modules 519, 512, 513, 514 and 515.

It will therefore be understood here that, like the illustration in FIG. 4, the coding of the following image may be carried out by block of pixels, with motion compensation with reference to any block from one of the reference images thus reconstructed.

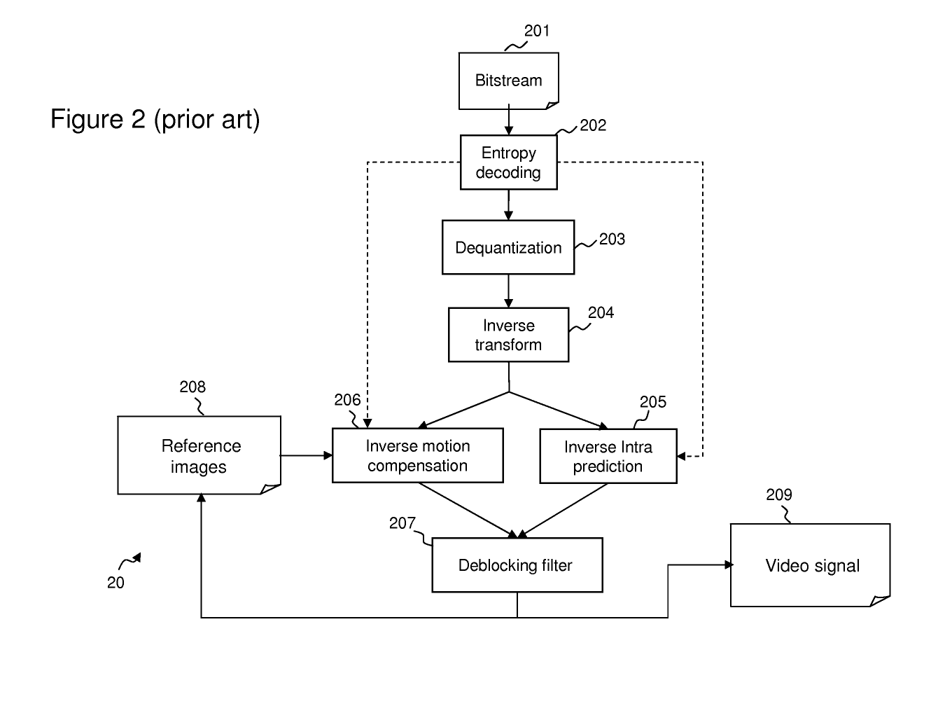

With reference now to FIG. 6, a decoder 20 according to the first embodiment comprises decoding processing modules 601 to 609 equivalent to the modules 201 to 209 described above in relation to FIG. 2, for producing a video signal 609 for the purpose of a reproduction of the video sequence by display. In particular, the dequantization module 603 implements for example the formula Wᵢ′=(qᵢ·|Zᵢ|−θᵢ)·sgn(Zᵢ) disclosed previously.

By way of illustration and for reasons of simplification of representation, the images 451 to 457 (FIG. 4) may be considered as the coded images constituting the bitstream 510 (the entropy coding/decoding not modifying the information of the image). The decoding of these images generates in particular the conventional reconstructed images making up the output video signal 609.

The reference image module 608 is similar to the module 208 of FIG. 2 and, by analogy with FIG. 5, it is composed of a module for the multiple “second” reconstructions 611 and a module containing the conventional reference images 610.

At the start of the decoding of the current image, the number of multiple reconstructions is extracted from the bitstream 601 and decoded entropically. Similarly, the parameters (coefficient number and corresponding offset) of the “second” reconstructions are also extracted from the bitstream, decoded entropically and transmitted to the second reconstruction parameter module or modules 613.

In this example, the process of a single second construction is described, although in the same manner as for the coder 10, other reconstructions may be performed, possibly in parallel, with suitable modules.

Thus a second dequantization module 612 calculates, for each data block, an inverse quantization different from the “conventional” module 603.

In this new inverse quantization, for the number of the coefficient given in parameter 613, the dequantization equation is applied with the reconstruction offset θᵢ also supplied by the second reconstruction parameter module 613.

The values of the other coefficients of each residue are, in this embodiment, dequantized with a reconstruction offset similar to the module 603, generally equal to zero.

As for the encoder, the residue (transformed, quantized, dequantized) output from the module 612 is detransformed (604) by application of the transform that is inverse to the one 507 used on coding.

Next, depending on the coding of the current block (Intra or Inter), an inverse motion compensation 606 or an inverse Intra prediction 605 is performed.

Lastly, when all the blocks of the current image have been decoded, the new reconstruction of the current image is filtered by the deblocking filter 607 before being inserted among the multiple “second” reconstructions 611.

This path for the residues transformed, quantized and dequantized by the second inverse quantization 612 is symbolized by the arrows in dashed lines. It should be noted that these “second” reconstructions of the current image are not used as video signal output 609. To be precise, these other reconstructions are only used as supplementary reference images for later predictions, whereas only the image reconstructed conventionally constitutes the video output signal 609.

Because of this non-use of the “second” reconstruction as an output signal, in a variant embodiment aimed at reducing the calculations and the processing time, it is provided to reconstruct, as a “second” reconstruction, only the blocks of the “second” reconstruction that are actually used for the motion compensation “Actually used” means a block of the “second” reconstruction that constitutes a reference (that is to say a block predictor) for the motion compensation for a block of a subsequently encoded image in the video sequence.

A simplified embodiment of the invention will now be described with reference to FIGS. 7 and 8. In this second embodiment, the “second” reconstructions are no longer produced from the quantized residues by applying, for each of the reconstructions, all the steps of inverse quantization 519, inverse transformation 512, Inter/Intra determination 513-514 then deblocking 515. These “second” reconstructions are produced more simply from the “conventional” reconstruction producing the conventional reference image 517. Thus the other reconstructions of an image are constructed outside the decoding loop.

In the encoder 10 of FIG. 7, the modules 701 to 715 are similar to the modules 101 to 115 in FIG. 1 and to the modules 501 and 515 in FIG. 5. These are modules for conventional processing according to the prior art.

The reference images 716 composed of the conventional reference images 717 and the “second” reconstructions 718 are respectively similar to the modules 516, 517, 518 of FIG. 5. In particular, the images 717 are the same as the images 517.

In this second embodiment, the multiple “second” reconstructions 718 of an image are calculated after the decoding loop, once the conventional reference image 717 corresponding to the current image has been calculated.

The “second reconstruction parameters” module, one operation of which will be detailed below, supplies a coefficient number i and a reconstruction offset θᵢ to the module 720, called the corrective residue module.

As for module 520, the two parameters generated by module 719 are entropically coded by module 709, then inserted in the bitstream (710).

The latter module 720 calculates an inverse quantization of a block of coefficients the values of which are all equal to zero. During this dequantization, the value of the coefficient having the position i supplied by the module 719 is dequantized by the equation Wᵢ′=(qᵢ·|Zᵢ|−θᵢ)·sgn(Zᵢ) by applying the reconstruction offset θᵢ supplied by that same module 719 and different from the offset (generally zero) used at 711. This inverse quantization results in a block of coefficients in which the value of the coefficient number i takes the value θᵢ and the other coefficient values themselves remain at zero.

The generated block then undergoes an inverse transformation, which provides a corrective residual block.

Next, the corrective residual block is added to each of the blocks of the conventionally reconstructed current image 717 in order to supply a new reference image, which is inserted in the module 718.

It will thus be remarked that the module 720 produces a corrective residue aimed at correcting the conventional reference image as “second” reference images as they should have been by application of the second reconstruction parameters used (at module 719).

This method is less complex than the previous one because it avoids performing the decoding loop (steps 711 to 715) for each of the “second” reconstructions and also because it suffices to calculate the corrective residue only once at module 720.

In particular, it will be noted that this second embodiment is propitious to the absence of storage of the multiple “second” reconstructions 718, given that it is easy to calculate these on the fly (at the time of performing the motion compensation) from the conventional reference image and the corrective residues 720. In particular, it may be provided only to reconstruct the predictor blocks when they are used for the de(coding) of a current block.

Note that the use of several types or sizes of transform or the use of adaptive quantization step sizes QP involves the calculation of second residues adapted to these parameters. For example, in the H.264 standard, when two sizes of transform are used (4×4 and 8×8), the calculation of two corrective residues 720 should be necessary: a corrective residue of size 4×4 that is added to the blocks coded with the 4×4 transform and a corrective residue of size 8×8 that is added to the blocks coded with the 8×8 transform.

Experimentally, it has been noticed that the application of a single corrective residual of size 4×4 to each of the 4×4 blocks of the 8×8 block is as effective as the use of these two second corrective residues even if both the transform sizes are used. Thus it may be provided to apply a lower number of corrective residues than the number of transform sizes. For example, only the residual of smallest size is kept, here 4×4.

Lastly, in a similar manner to the first embodiment, other “second” reconstructions of the current image are obtained using the corrective residual module 720 several times with different second reconstruction parameters 719.

It should be noted that the approaches in FIGS. 5 and 7 can be mixed to produce “second” reconstructions in a mixed manner.

With reference now to FIG. 8, the decoder 20 corresponding to this embodiment comprises modules 801 to 809 equivalent to modules 201 to 209 (and therefore 601 to 609). In addition, the module of the reference images 808 is similar to the module 608, with conventional reference images 810 (similar to 610) and multiple “second” reconstructions 811 (similar to 611).

As for the coding in FIG. 7, complete decoding is here performed only for the conventional reference image (which is used as video output 209), the other reconstructions being produced using corrective residues 812.

In detail, at the start of the decoding of the current image, the number of multiple reconstructions is extracted from the bitstream 801 and decoded entropically. Similarly, the parameters of the “second” reconstructions are also extracted from the bitstream, decoded entropically and transmitted to the second reconstruction parameters module 813.

These parameters are used to create a corrective texture residue 812. This residue is calculated in the same way as in the module 720: from a null block to which there are applied an inverse quantization, the quantization offset of which is modified for a particular coefficient number, and then an inverse transformation.

At the end of the decoding of the current image 807, this corrective residue 812 is added to each of the blocks of the current image before the resulting reference image is inserted among the multiple other reconstructions 811.

As a variant, this corrective residue can be applied only to the blocks actually used for a subsequent prediction.

As for the coding, the calculation of the corrective residue 812 may depend on the size or the transformation type used or the quantization step size QP used for coding each block.

The “second” decoding/reconstructions of the current image are obtained using the corrective residue module 812 several times with other second reconstruction parameters 813 extracted from the bitstream and decoded.

A description is now given of the operation of the modules 520 and 719 for the selection of optimum coefficients and associated reconstruction offsets. The algorithms described below may in particular be used for selections of parameters of other types of decoding/reconstruction of a current image into several “second” reconstructions: for example, reconstructions applying a contrast filter and/or a fuzzy filter on the conventional reference image. In this case, the selection may consist of choosing a value for a particular coefficient of a convolution filter used in those filters, or of choosing the size of that filter.

It should be noted that the modules 613 and 813 provided on decoding generally just retrieve information from the bitstreams. In certain cases described below, these modules may however perform the determination of those parameters. In this case, those parameters are not transmitted in the bitstream 510, 601, 710, 801 (or else partially), which improves the compression.

As introduced previously, in the embodiment described here, two parameters are used for performing a “second” reconstruction: the number i of the coefficient to be dequantized differently and the reconstruction offset θᵢ chosen to perform this different inverse quantization.

The modules 520 and 719 automatically select these parameters for a second reconstruction.

In detail, with regard to the quantization offset, it is first of all considered, to simplify the explanations, that the quantization offset fᵢ of the above equation

$${Z}_{i} = int ( \frac{\vert {W}_{i} \vert + {f}_{i}}{{q}_{i}} ) \cdot sgn ( {W}_{i} )$$

is always equal to qᵢ/2. Due to the nature of the quantization and inverse quantization processes, the optimal reconstruction offset θᵢ belongs to the interval [−qᵢ/2;qᵢ/2].

As specified above, the “conventional” reconstruction for generating the signal 609/809 generally uses a zero offset (θᵢ=0)

Several approaches for setting the offset associated with a given coefficient (the selection of the coefficient is described below), for a “second” reconstruction, may then be provided: However, in an embodiment, the number of coefficients from among which the selection will be made is reduced. To be precise, since the offset associated with these coefficients is calculated in advance, this subset of coefficients enables the calculation complexity to be reduced, both with regard to the determination of the associated offsets, and with regard to the later selection of the coefficient or coefficients kept for performing the “second” reconstruction.

This processing in advance comprises different sub-steps.

First of all, for each block of the image to reconstruct, values are obtained that are calculated on the basis of the coefficients of the block, in particular in the frequency domain. This may in particular be a matter of transforming each of the blocks of the image coming from the “conventional” reconstruction (517, 610, 717, 810) by a DCT transform making it possible to obtain, for each block, values Wᵢ′ of coefficients which, by definition, represent an item of spatial frequency information.

In order to improve the efficiency of this processing, the size chosen for this transform (DCT) is the same as that used in the other reconstructions, for example a 4 pixels×4 pixels DCT.

Secondly, calculation is made of the sum Sumᵢ of the values so calculated by transform and corresponding to coefficients of the same index i over all the blocks so transformed:

$${Sum}_{i} = {\sum }_{j ∈ current image} {W}_{i , j}^{′}$$

where W_{i,j}′ is the value of the coefficient i of the transformed block j in the current image to reconstruct. This sum thus reflects the relative importance of the block coefficients compared with each other over the whole of the image.

When DCT blocks of 4 pixels×4 pixels are used, there are thus sixteen sums that are calculated, corresponding to the sixteen coefficients i=0 to 15.

Lastly (thirdly), from the set I={0, . . . , 15} of these (sixteen) coefficients, those that are not pertinent are deleted, in particular the coefficients kεI verifying

$${Sum}_{k} < \frac{Max ( {Sum}_{l} , ∀ l ∈ I )}{Δ}$$

where Max refers to the maximum value and Δ is a variable which depends in particular on the content of the sequence, on the quantization step size QP, on the quantization matrix and/or on the performance of the (de)coder. Δ may be preset by the user, for example Δ=20. By making Δ vary, the user may thus reduce the subset I′ so obtained in order to further reduce the complexity for the following steps.

A subset I′ is thus obtained comprising a number of coefficient indices that is restricted compared to the sixteen coefficients initially possible in our example.

By using the image from the “conventional” reconstruction, it is possible to have these same processing operations carried out at the decoder without transmitting specific parameters (except perhaps Δ if this is not predefined globally or cannot be determined). Thus, without compression loss, the decoder may also determine the coefficients thus selected (the subset I′ and possibly those resulting from the selecting described later).

As a variant, instead of determining the subset I′ on the basis of the “conventional” reconstruction of the current image, a DCT transform may be applied directly to the current image (the image i-1 of FIG. 4 for example) and perform the calculations of the Sumᵢ on the basis of the coefficient values so obtained. In this case however, the selected coefficients (either I′, or those from the selection hereinafter) must be communicated (in the bitstream) to the decoder, since the latter does not have knowledge of the current image.

In another variant which reduces the calculation complexity, the obtainment of the values calculated on the basis of the coefficients of the block may consist in directly retrieving the coefficients W_{i,j}′ generated in the decoding loop at the time of the “conventional” reconstruction. In this case, the dequantization block 511/711 communicates to the block 520/719 the dequantized residue corresponding to each block (dashed arrows in FIGS. 5 and 7), to which the following steps are applied (calculations of the Sumᵢ and deletions to obtain I′). The calculations relative to a new DCT transform are thus avoided.

It should be noted that, in this case, the value Δ used in the third sub-step is reduced, for example Δ=4, to take into account the fact that the coefficients of the block residue are manipulated here.

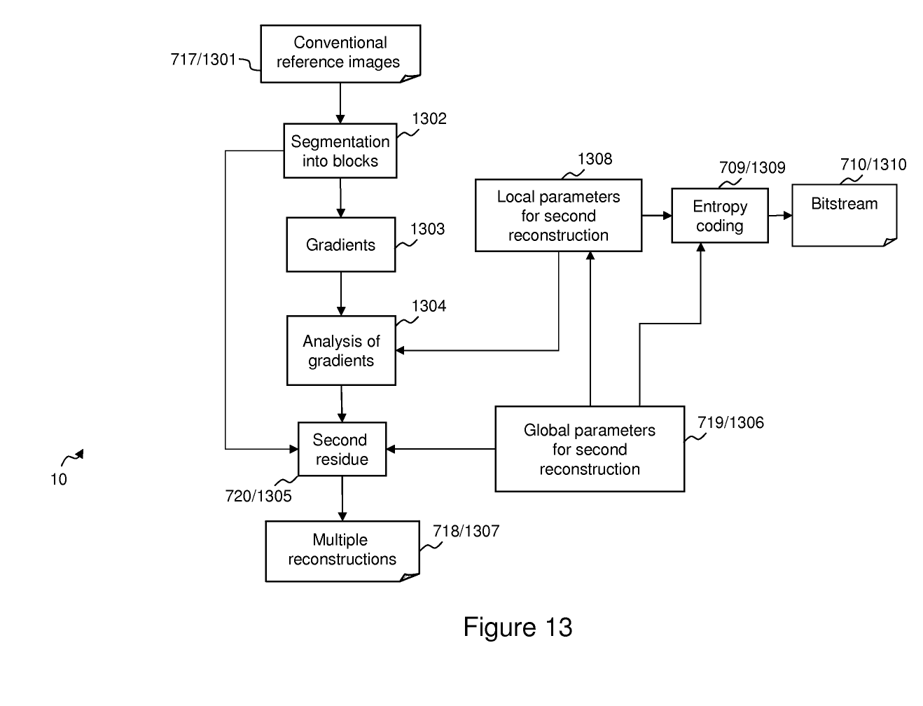

Lastly, instead of the use of the DCT transform, it is possible to use other transformations to evaluate the importance of the coefficients, for example the calculation of gradients, as illustrated below with reference to FIG. 13.

It should also be noted that the determination of the subset I′ is carried out here before the calculation of the quantization offsets θᵢ, in order to limit the number thereof. However, the invention also makes it possible for this subset to be applied only on determination of the coefficients to which those offsets are applied (see below).

In an embodiment, this subset I′ may be even further restricted, for example by deleting therefrom any coefficient k which has already been used in at least n preceding reconstructions of the current image to reconstruct (n being predetermined, for example n=2). Thus, even further reduction in complexity is made for the calculations to come for determining the offsets and the coefficients chosen for a new “second” reconstruction of the same current image.

Once the subset I′ has been established, the offset is thus set that is associated with each of the coefficients i of that subset or of the sixteen DCT coefficients if the construction of the subset I′ is not implemented, the setting being according to one of the following approaches:
according to a first approach: the choice of θᵢ is fixed according to the number of multiple “second” reconstructions of the current image already inserted in the list 518/718 of the reference images. This configuration provides reduced complexity for this selection process. This is because it has been possible to observe that, for a given coefficient, the most effective reconstruction offset θᵢ is equal to qᵢ/4 or −qᵢ/4 when a single reconstruction of the first image belongs to all the reference images used. When two “second” reconstructions are already available (using qᵢ/4 and −qᵢ/4), an offset equal to qᵢ/8 or −qᵢ/8 gives the best mean results in terms of rate/distortion of the signal for the following two “second” reconstructions, etc;
according to a second approach: the offset θᵢ may be selected according to a rate/distortion criterion. If it is wished to add a new “second” reconstruction of the first reference image to all the reference images, then all the values (for example integers) of θᵢ belonging to the interval [−qᵢ/2;qᵢ/2] are tested; that is to say each reconstruction (with θᵢ different for the given coefficient i) is tested within the coding loop. The quantization offset that is selected for the coding is the one that minimizes the rate/distortion criterion;
according to a third approach: the offset θᵢ that supplies the reconstruction that is most “complementary” to the “conventional” reconstruction (or to all the reconstructions already selected) is selected. For this purpose, the number of times where a block of the evaluated reconstruction (associated with an offset θᵢ, which varies over the range of possible values because of the quantization step size QP) supplies a quality greater than the “conventional” reconstruction block (or than all the reconstructions already selected) is counted, the quality being able to be assessed with a distortion measurement such as an SAD (absolute error—“Sum of Absolute Differences”), SSD (quadratic error—“Sum of Squared Differences”) or PSNR (“Peak Signal to Noise Ratio”). The offset θᵢ that maximizes this number is selected.

According to the same approach, it is possible to construct the image each block of which is equal to the block that maximizes the quality among the block with the same position in the reconstruction to be evaluated, that of the “conventional” reconstruction and the other second reconstructions already selected. Each complementary image, corresponding to each offset θᵢ (for the given coefficient), is evaluated with respect to the original image according to a quality criterion similar to those above. The offset θᵢ the image of which constructed in this way maximizes the quality, is then selected.

The choice of the coefficient to modify is next proceeded to, in particular for the “global approach” whereby the same block coefficient is modified for all the blocks of the image to reconstruct. This choice consists in selecting the optimum coefficient from among the coefficients of the subset I′ when this has been constructed, or from among the sixteen coefficients of the block.

Several approaches are then envisaged, the best offset θᵢ being already known for each of the coefficients as determined above:
first of all, the coefficient used for the second reconstruction is predetermined. This manner of proceeding gives low complexity. In particular, the first coefficient (coefficient denoted “DC” in the state of the art) is chosen. To be precise, it has been possible to note that the choice of this DC coefficient enables “second” reconstructions to be obtained having the best mean results (in terms of rate-distortion). As a variant, the coefficient corresponding to the maximum sum Sumᵢ as defined earlier may be taken.
in a variant, the reconstruction offset θᵢ being set, determining θᵢ is carried out in similar manner to the second approach above: the best offset for each of the coefficients of the block or of the subset I′ is applied and the coefficient which minimizes the rate-distortion criterion is selected.
in another variant, the coefficient number may be selected in similar manner to the third approach above to determine θᵢ: the best offset is applied for each of the coefficients of the subset I′ or of the block and selection is made the coefficient which maximizes the quality (greatest number of blocks evaluated having a quality better than the “conventional” block).
in still another variant, it is possible to construct the image each block of which is equal to the block that maximizes the quality, among the block with the same position in the reconstruction to be evaluated, those of the “conventional” reconstruction and the other second reconstructions already selected. The coefficient from the block or the subset I′ which maximizes the quality is then selected.

These few examples of approaches enable the modules 520 and 719 to be provided with pairs (coefficient reference number, reconstruction offset) for piloting the modules 519 and 720 and performing a corresponding number of “second” reconstructions.

In certain cases, as referred to above, the modules 613 and 813 of the decoder 20 may perform the same processing operations to obtain the same pairs. Transmitting these latter in the bitstream is thus avoided.

With reference now to FIGS. 10 to 13, a description is given of an improvement in the coding efficiency in which the coefficients modified for the “second” reconstructions vary from block to block.

The main case was described above in which the same coefficient number is modified in similar manner for all the blocks of the image to reconstruct. This approach is designated, in what follows, “global approach”.

FIGS. 10 to 13 present a “local” approach in which the modified coefficients are specific to each block.

However the invention enables the “global” and “local” approaches to be combined, without difficulty: for example, certain “second” reconstructions may implement the global approach and others the local approach, or else in the same reconstruction, certain coefficients (in particular the DC continuous coefficient of the DCT transform) may be processed according to the global approach (use of the quantization offset in all the blocks of the image) and other coefficients according to the local approach.

In order to identify which approach is used, provision is made to add a flag to the bitstream, specifying whether the local approach is used, and a flag specifying whether the global approach is used. If the local approach flag is equal to 1 a list of {coefficient i; offset θᵢ} pairs is inserted into the bitstream after that flag. This list corresponds to the parameters of the local approach. If the embodiment for the local approach uses all the coefficients in a block then the coefficient numbers i may be omitted and are not inserted into the bitstream to improve the compression.

FIGS. 10 to 13 illustrate three different algorithms relative to this “local” approach. These also implement a (spatio-)frequency analysis to determine the block coefficient or coefficients to modify at the time of the “second” reconstructions. “(Spatio-)frequency analysis” means an analysis of the spatial content of the blocks, in particular by frequency transformation by block, like DCT for example, or any other “spatio-frequency” transformation applied to a spatial region of the image (which may include the gradient calculation or wavelet transform type transformation).

FIG. 10 illustrates particularities of the coder 10 of FIG. 7 for the first algorithm. The references common to those of FIG. 7 have thus been carried over to FIG. 10, certain modules of FIG. 7 not being reproduced in FIG. 10. It is to be noted that to take into account the global and local approaches, the module 719/1006 has been renamed “global parameters for second reconstruction” and the new module 1008 has been named “local parameters for second reconstruction”.

It is also to be noted that, with slight modifications within the capability of the person skilled in the art, this first algorithm integrates into the coder of FIG. 5.

As mentioned earlier, selecting the coefficient reference numbers to use to apply the quantization offsets may be carried out on the basis of the conventional reference images 717/1001. However, as a variant, it is to be recalled that the invention also makes it possible to use original images (for example i-1 in FIG. 4).

At the start of this first algorithm, the module 719/1006 knows the {offset; coefficient} pairs to apply according to the global approach, as described above with reference to FIGS. 5 to 8.

For its part, module 1008 defines a set of {offset; coefficient} pairs for all the possible coefficients i=0 to 15. These pairs may in particular arise from the processing operations described above.

In an embodiment, module 1008 receives, from module 719/1006, the coefficients used in the global approach and deletes them so as to constitute a restricted set of pairs. It thus avoids calculating the offsets corresponding to those coefficients that have already been used. It is to be noted that if it is the DC continuous coefficient, it is nevertheless kept. On the other hand, the corresponding quantization offset is set to zero without calculation.

Module 1002 performs conventional segmentation of the current reference image into blocks, in particular of the size of the DCT transform, for example 4 pixels×4 pixels. Each block is then transformed by the DCT (module 1003), then analyzed at the analysis module 1004.

Module 1008 sends the analysis module 1004 all the {offset, coefficient} pairs.

For each transformed block, the module 1004 then selects the coefficient having the maximum value, (with the possible exclusion of the coefficients used in the global approach), the value of the DC continuous coefficient being divided by 10 at that selection since it is generally considerably greater than the other values of the block. Of course, several coefficients (having the maximum values) may be selected in a particular embodiment.

Module 1004 then retrieves the {offset, coefficient} pair corresponding to the selected coefficient, on the basis of the information received from the module 1008. This pair is then transmitted to the “second residue” module 720/1005.

In similar manner to that described above for the module 720 with reference to FIG. 7, the module 720/1005 calculates a corrective residual block taking into account the different {coefficient i; offset θᵢ} pairs coming both from the global approach (coefficient and offset supplied by module 719/1006) and from the local approach (coefficients and offsets supplied by module 1004).

This corrective residue is added to the current block given by module 1002. All the blocks are processed in this manner to generate a “second” reconstruction of the first reference image. The corresponding reference image is then inserted into the module 718/1007 and may be used conventionally for predictions as described above.

In parallel, the list of the {coefficient; offset} pairs is coded at the coding module 709/1009 to be inserted into the bitstream 710/1010.

In an embodiment, modules 1006 and 1008 supply a single offset θᵢ per coefficient number for all the blocks of a given image. In the example of the 4×4 DCTs, there are thus a maximum of 16 offsets. These are then place in a predetermined order, for example the same order as the coefficients (zig-zag scan), encoded then inserted in the header of the current frame coding the image.

By way of example, if only the coefficients 0, 1, 2, 3 and 5 are used for the “second” reconstructions of the current image, the ordered list {θ₀, θ₁, θ₂, θ₃, θ₅} is inserted in the bitstream.

Thus, the compression of the video sequence is substantially improved compared to the case in which, for the local approach, the offsets are indicated block by block.

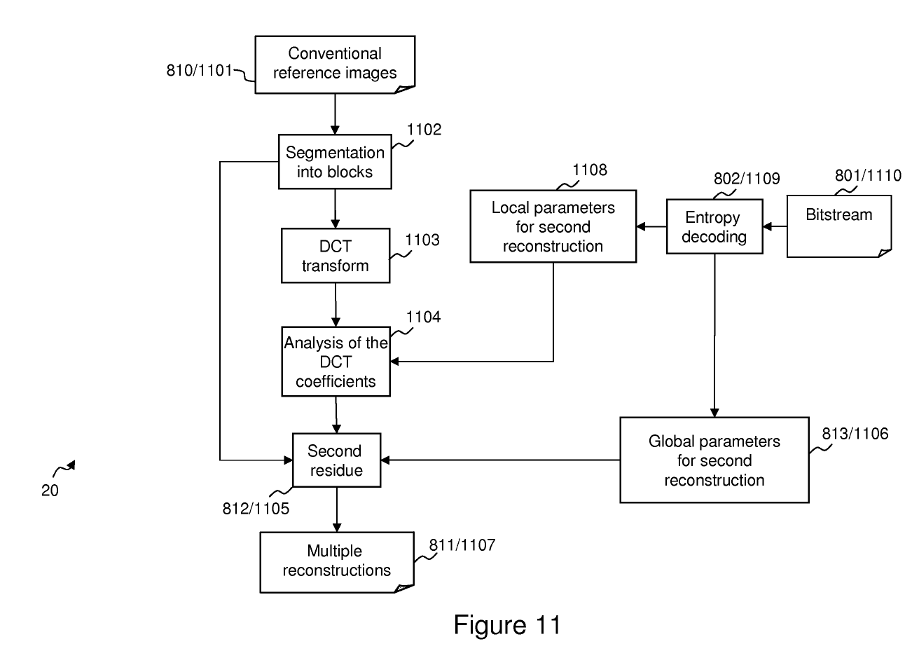

FIG. 11 illustrates particularities of the decoder 20 of FIG. 8 for the first algorithm. The references common to those of FIG. 8 have thus been carried over to FIG. 11, certain modules of FIG. 8 not being reproduced in FIG. 11. In similar manner to FIG. 10, the module 813/1106 has been renamed “global parameters for second reconstruction” and the new module 1108 has been named “local parameters for second reconstruction”.

It is also to be noted that, with slight modifications within the capability of the person skilled in the art, this first algorithm integrates into the decoder of FIG. 6.

The operation of the decoder 20 is similar to that of the coder 10, taking into account the decoding process instead of the coding process. In particular, the {coefficient; offset} pairs used may be extracted from the bitstream 801/1110, when they are not directly deduced from a “conventional” reconstruction, then decoded by module 802/1109.

They are then transmitted to the modules for local/global parameters for second reconstruction 1108 and 813/1106.

The first (local parameters) are next transmitted to analysis module 1104 which determines which parameters to use specifically for a given block to reconstruct according to the local approach.

These specific parameters as well as the global parameters are transmitted to the second residue module 812/1105 which calculates the corrective residue according to the mechanisms referred to previously, so as to generate each of the blocks of a second reconstruction.

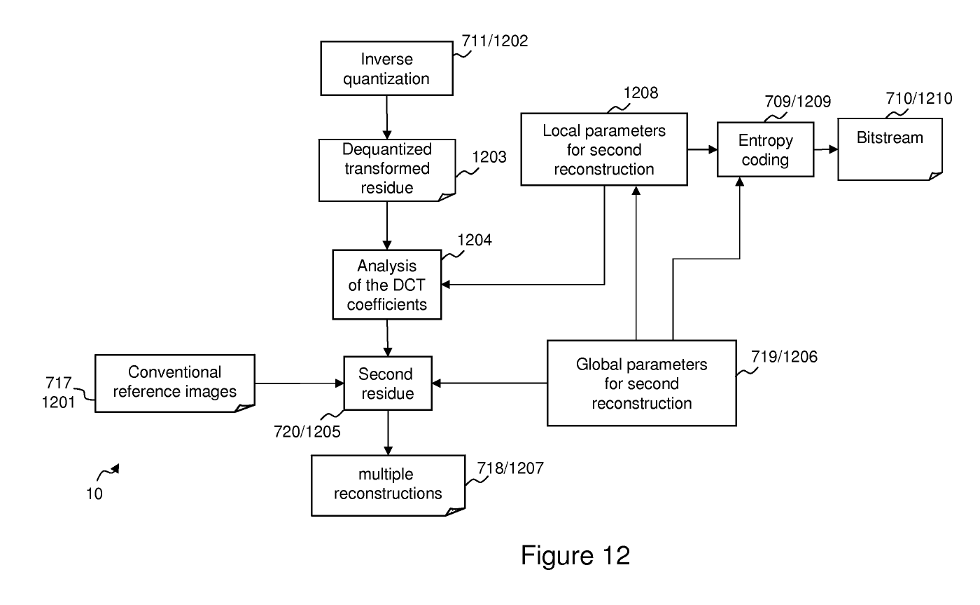

FIG. 12 illustrates particularities of the coder 10 of FIG. 7 for the second algorithm example. The references common to those of FIG. 7 have thus been carried over to FIG. 12, certain modules of FIG. 7 not being reproduced in FIG. 12. In similar manner to FIG. 10, the module 719/1206 has been renamed “global parameters for second reconstruction” and the new module 1208 has been named “local parameters for second reconstruction”.

The same modifications as those mentioned previously may be made in order to apply these particularities to the coder 10 of FIG. 5.

In this embodiment, instead of starting from the conventional reference images, the dequantized transformed coefficients are directly retrieved as output from the inverse quantization module 711/1202. This processing is shown schematically in FIGS. 5 and 7 by the dashed arrows between modules 511/711 and 520/719. Thanks to this retrieval, this second algorithm is of lower complexity than the first.

The modules 719/1206 and 1208 of parameters for second reconstruction are similar to modules 719/1006 and 1008 of FIG. 10.

Module 711/1202 produces as output the block residues which are transformed, quantized then dequantized as described above.

The analysis module 1204 is similar to module 1004, and thus processes the dequantized residues (1203) so obtained for selecting at least one {coefficient; offset} pair to apply specifically to the block current. However, no scaling (division by 10 in the above example) of the DC continuous coefficient is made at the step of selecting the coefficient having the maximum value, since the block residues are being processed here.

The second residue module 720/1205 then calculates the corrective residue of the current block from at least one {coefficient; offset} pair selected by the module 1204 and possibly from the {coefficient; offset} pair transmitted by the global approach module 1206.

This corrective module is added to the corresponding block of the “conventional” reference image to progressively create a second reconstruction.

The decoding part is similar to that described above with reference to FIG. 11, taking into account the particularities of the second algorithm.

FIG. 13 illustrates particularities of the coder 10 of FIG. 7 for the third algorithm example. The references common to those of FIG. 7 have thus been carried over to FIG. 13, certain modules of FIG. 7 not being reproduced in FIG. 13. In similar manner to FIG. 10, the module 719/1306 has been renamed “global parameters for second reconstruction” and the new module 1308 has been named “local parameters for second reconstruction”.

The same modifications as those mentioned previously may be made in order to apply these particularities to the coder 10 of FIG. 5.

In this embodiment, the selection of the coefficients/offsets specific to a given block (local parameters) is carried out on the basis of an analysis of gradients and no longer on the basis of a DCT transform analysis.

In preconfigured manner, the module 1308 associates three coefficient indices in the zig-zag scan of DCT blocks (those used during the second reconstructions) with three variables G_{X}, G_{Y} and G/δ. These variables are defined subsequently. With each of these indices there is also associated a quantization offset θᵢ calculated according to one of the approaches described above.

As a variant, several offsets and/or several {coefficient; offset} pairs may be associated with each of these variables, according to the value they take for example, a {coefficient; offset} pair for each range of values that a variable may take.

In particular, the coefficient associated with G/δ is the first coefficient (DC continuous coefficient), and in the case in which this DC coefficient is used in the global approach (by the module 719/1306), the associated offset is equal to 0.

The coefficient associated with G_{X} is chosen from the first column of a DCT block, with the exception of the DC coefficient, and in particular the second coefficient in that column is chosen. This is thus the coefficient of lowest frequency after the DC coefficient in that column, and which represents the principal variation of the pixels of the block along the horizontal axis.

Similarly, the coefficient associated with G_{Y} is chosen from the first row of a DCT block, with the exception of the DC coefficient, and in particular the second coefficient in that row is chosen. This is thus the coefficient of lowest frequency after the DC coefficient in that row, and which represents the principal variation of the pixels of the block along the vertical axis.

As a variant, the mechanisms for determination and automatic selection of the coefficient index for each variable may be implemented, in particular on the basis of statistical information on the DCT blocks.

Considering a “conventional” reference image (717/1301) to reconstruct into a “second” reconstruction, module 1302 segments this image into blocks in a conventional manner and transmits them successively to the gradient calculating module 1303 for calculating the values G_{X}^{i,j}, G_{Y}^{i,j} and G^{i,j} representing spatial frequency information with regard to each pixel (i,j).

For a current block, the module 1303 calculates, for each pixel (i, j) of the block:
the horizontal gradient

$${G}_{X}^{i , j} = [ \begin{matrix}- 1 & 0 & 1 \\ - 2 & 0 & 2 \\ - 1 & 0 & 1\end{matrix} ]$$

[symbol]

A where [symbol] is the convolution operation and A is a 3×3 matrix including, at the center, the value of the pixel (i,j) and around this, the eight neighboring pixels (with, for the border pixels, copying of border pixels to obtain the missing pixels). It is to be noted that if the pixels (i,j) have several components (Red-Green-Blue for example), each of the components is treated separately;
the vertical gradient

$${G}_{Y}^{i , j} = [ \begin{matrix}1 & 2 & 1 \\ 0 & 0 & 0 \\ - 1 & - 2 & - 1\end{matrix} ] ⊗ A ;$$

the gradient G^{i,j}=\sqrt{G_{X}^{i,j}^{₂}+G_{Y}^{i,j}^{₂}}.

These various gradients are well-known to the person skilled in the art thanks to the Sobel algorithm for example. These gradients are next transmitted, for all the pixels of the current block, to module 1304.

The analysis module 1304 then calculates the sums of the different gradients on the current block, and in particular:

$${G}_{X} = {\sum }_{( i , j ) ∈ current block} {G}_{X}^{i , j} , \\ {G}_{Y} = {\sum }_{( i , j ) ∈ current block} {G}_{Y}^{i , j} , and$$

$$G = {\sum }_{( i , j ) ∈ current block} {G}^{i , j} .$$

The analysis module next compares the three values G_{X}, G_{Y} and G/δ where δ is a variable which depends in particular on the content of the sequence, on the quantization step size QP, on the quantization matrix and/or on the performance of the (de)coder, for example δ=3.

In an embodiment, it selects the coefficient and the associated offset which correspond to the maximum value from among the three compared values. For example, if G_{X} proves to be the maximum of the three values, the module 1304 therefore selects the {coefficient; offset} pair which is associated, in module 1308, with G_{X}.

In similar manner to what has been described supra for the “second residue” modules, the module 720/1305 next calculates the corrective residue for each block then the corrected block so as lastly to construct a “second” reconstruction.

In parallel, the three {coefficient; offset} pairs which are valid for all the blocks of the current image (even if from block to block, it is not the same coefficient which is modified) are transmitted to the coding module 709/1309 which inserts them into the bitstream 710/1310 in coded form.

Once again, the decoding is similar to that described above with reference to FIG. 11, taking into account the particularities of the third algorithm. This third algorithm is in particular of lower complexity compared to the first algorithm implementing the DCT transformation.

In an embodiment, a higher number of gradients may be provided and not just three. For example, sixteen different gradients may be used, each associated with one of the DCT block coefficients.

It should be noted that the invention may apply to the routine use of the reference image that is closest in terms of “temporal” distance to the current image, to produce the “second” reconstructions. This is because this use of the closest image ensures a good rate-distortion ratio compared to the other more remote images.

However, more elaborate mechanisms for choosing a particular reference image for each block of the image, on the basis of a rate-distortion criterion, also enable the rate-distortion performance to be improved on coding. Care will nevertheless be taken to limit the number of reference images used for the same image to code to four, as recommended by the VCEG group.

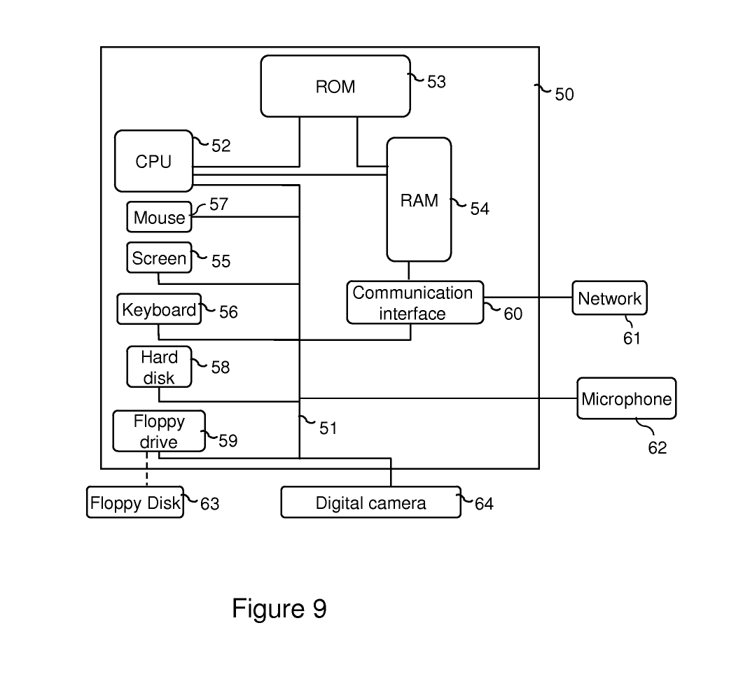

With reference now to FIG. 9, a description is given by way of example of a particular hardware configuration of a video sequence processing device adapted for an implementation of the method according to the invention.

An information processing device implementing the present invention is for example a micro-computer 50, a workstation, a personal assistant, or a mobile telephone connected to different peripherals. According to still another embodiment of the invention, the information processing device takes the form of a camera provided with a communication interface to enable connection to a network.

The peripherals connected to the information processing device comprise for example a digital camera 64, or a scanner or any other means of image acquisition or storage, connected to an input/output card (not shown) and supplying multimedia data, for example of video sequence type, to the information processing device.

The device 50 comprises a communication bus 51 to which there are connected:
a central processing unit CPU 52 taking for example the form of a microprocessor;
a read only memory 53 in which may be contained the programs whose execution enables the implementation of the method according to the invention. It may be a flash memory or EEPROM;
A random access memory 54, which, after powering up of the device 50, contains the executable code of the programs of the invention necessary for the implementation of the invention. As this memory 54 is of random access type (RAM), it provides fast accesses compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62. The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing (coding or decoding) a video sequence, and which may possibly be removable, is adapted to store one or more programs whose execution permits the implementation of the method according to the invention.

The executable code enabling the video sequence processing device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 4 to 8 and 10 to 13, to implement the methods of the present invention and constitute the devices of the present invention.

The preceding examples are only embodiments of the invention which is not limited thereto.

In particular, the embodiments described above principally provide for the generation of “second” reference images for which only one (coefficient number, quantization offset) pair is different relative to the “conventional” reference image. It may however be provided for a greater number of parameters to be modified to generate a “second” reconstruction: for example several (coefficient; offset) pairs.

What is claimed, is:

1. A method of processing a video sequence (101, 201, 501, 601, 701, 801) constituted by a series of digital images (401 to 407) comprising a current image (401) to process, said images being composed of data blocks each formed from a set of coefficients each taking a value, said method comprising the steps of:
generating (511, 603, 720, 812, 519, 612, 720, 812) at least first and second reconstructions (402 to 413), which are different from each other, of at least a same first image (i-1 to i-n) of the sequence, so as to obtain at least first and second reference images (517, 610, 717, 810, 518, 611, 718, 811), the second reconstruction implementing, on at least one coefficient of a block, a different operation to that implemented at the first reconstruction on the same block coefficient;
predicting (505, 606, 705, 806) at least a part (414, 415, 416) of said current image (401) on the basis of at least one of said reference images (516, 608, 716, 808)
and wherein the second reconstruction of the first image comprises the steps of:
obtaining, for at least one block of the first image, values (Wᵢ, G_{X}^{i,j}, G_{Y}^{i,j}, G^{i,j}) calculated on the basis of the block coefficients and representing spatial frequency information;
selecting at least one block coefficient according to said calculated values, and applying said different operation to it so as to obtain said second reference image.

2. A method according to claim 1, wherein the second reconstruction of the first image further comprises a step of determining a subset (I′) of block coefficients, according to said calculated values;
and selecting at least one block coefficient is carried out on said subset.

3. A method according to claim 2, wherein determining said subset comprises calculating, for each block coefficient and on the basis of said calculated values, at least a second value (Sumᵢ) representing the relative importance of the block coefficients compared with each other within said first image, and determining coefficients to constitute said subset by comparison of the second values with a threshold value (max/Δ).

4. A method according to claim 2, comprising a plurality of different reconstructions of the first image, and wherein the second reconstruction of the first image further comprises the step of deleting, from said subset, a coefficient on which said different operation has already been applied for a predefined number of reconstructions of the first image.

5. A method according to claim 1, wherein, given a selected coefficient, the second reconstruction comprises applying the different operation to said selected coefficient for each block of the first image to reconstruct.

6. A method according to claim 1, wherein, at the second reconstruction, the steps to obtain said calculated values and to select at least one coefficient are carried out repetitively for several blocks of the first image, so as to obtain a particular coefficient for each of those several blocks, and, in a said block, an operation is applied to the particular coefficient which operation is different to that implemented at the first reconstruction on the same block coefficient.

7. A method according to claim 6, wherein, at the second reconstruction, a said different operation is applied to at least one said first coefficient for each block of the first image to reconstruct and a said different operation is applied, for each block of the first image, to a particular selected coefficient of said block,
and selecting said particular coefficient before applying said different operation is carried out from a set of block coefficients excluding said at least one first coefficient.

8. A method according to claim 1, wherein the calculated values representing spatial frequency information are obtained by transforming the first reference image resulting from the first reconstruction.

9. A method according to claim 1, wherein the first reconstruction comprises inverse quantization of the coefficient values coming from a quantized version of said first image, and
for the second reconstruction, said calculated values are calculated on the basis of the dequantized values of coefficients obtained at the inverse quantization of the first reconstruction.

10. A method according to claim 1, wherein said calculated values are calculated for each block coefficient and represent a gradient in the neighborhood of the block coefficient.

11. A method according to claim 1, wherein the operation that is different from the second reconstruction implements an inverse quantization using, for said at least one selected block coefficient (Wᵢ), a different quantization offset (θᵢ) to that used for the same coefficient at the first reconstruction.

12. A method according to claim 1, wherein, for the set of the blocks composing a first given image, there is uniquely associated with a block coefficient a parameter (θ_{I}) defining said different operation to apply, for each block, to the block coefficient if it is selected,
and the method comprises a step of coding the current image into a coded stream (510, 710), and a step of inserting, into the coded stream, said parameters for the set of the blocks of a current image, in the form of a unique list organized in a predetermined order.

13. A device for processing (10, 20) a video sequence (101, 201, 501, 601, 701, 801) constituted by a series of digital images (401 to 407) comprising a current image (401) to process, said images being composed of data blocks each formed from a set of coefficients each taking a value, said device comprising:
a generating means adapted for generating at least first and second reconstructions (402 to 413), which are different from each other, of at least a same first image (i-1 to i-n) of the sequence, so as to obtain at least first and second reference images (517, 610, 717, 810, 518, 611, 718, 811), the second reconstruction implementing, on at least one coefficient of a block, a different operation to that implemented at the first reconstruction on the same block coefficient;
a predicting means adapted for predicting at least a part (414, 415, 416) of said current image (401) on the basis of at least one of said reference images (516, 608, 716, 808)
and wherein the generating means is configured, for generating the second reconstruction, for:
a means for obtaining, for at least one block of the first image, values (Wᵢ, G_{X}^{i,j}, G_{Y}^{i,j}, G^{i,j}) calculated on the basis of the block coefficients and representing spatial frequency information;
a means for selecting at least one block coefficient according to said calculated values, and applying said different operation to it so as to obtain said second reference image.

14. A means of information storage, possibly totally or partially removable, that is readable by a computer system, comprising instructions for a computer program adapted to implement the processing method according to claim 1, when the program is loaded and executed by the computer system.

15. A computer program product readable by a microprocessor, comprising portions of software code adapted to implement the processing method according to any claim 1, when it is loaded and executed by the microprocessor.
